(19) United States
(12) Patent Application Publication
(10) Pub. No.: US 2026/0367447 A1
(43) Pub. Date: Nov. 19, 2026

(54) MICRO-LENS COATED REFLECTIVE POLARIZER

(71) Applicant: 3M INNOVATIVE PROPERTIES COMPANY, St. Paul, MN (US)

(72) Inventors: Ke Li, Xiamen City (CN); Yan Zhuang, Qingdao City (CN); Kristopher J. Derks, Woodbury, MN (US)

(21) Appl. No.: 19/136,458

(22) PCT Filed: Dec. 12, 2022
(86) PCT No.: PCT/CN2022/138365

§ 371 Date: Jun. 6, 2025

(51) Int. Cl. G02F 1/13357; G02F 1/1335

(52) U.S. Cl. CPC G02F 1/13362; G02F 1/133607

(57) ABSTRACT

A backlight of an optical system including an optical stack having a prismatic film with a structured first surface and an opposite second surface, a first adhesive layer disposed on the second surface, a reflective polarizer disposed on the first surface, a second adhesive layer disposed between the reflective polarizer and the prismatic film, and a lens film disposed on, and bonded to, the reflective polarizer opposite the second adhesive layer. The lens film includes microlenses facing away from the prismatic film to form a two-dimensional array. For the pass direction and at least one visible wavelength, the optical stack has an on-axis effective transmission of at least about 1.5 along a thickness direction of the optical stack and an oblique effective transmission of at most about 1.2 along an oblique direction making an angle of at least 40 degrees with the thickness direction.

### SUMMARY

In some aspects of the present description, a backlight of an optical system including a display panel is provided, the backlight including an optical stack. The optical stack includes a prismatic film having a structured first major surface and an opposite second major surface, a first adhesive layer disposed on the second major surface, opposite the structured first major surface of the prismatic film, a reflective polarizer disposed on the structured first major surface, opposite the second major surface of the prismatic film, a second adhesive layer disposed between the reflective polarizer and prismatic film and bonding the reflective polarizer to the prismatic film, and a lens film disposed on, and bonded to, the reflective polarizer opposite the second adhesive layer and substantially co-extensive in width and length with the reflective polarizer. The structured major surface of the prismatic film includes a plurality of substantially linear prisms extending along a same longitudinal direction and arranged along an orthogonal transverse direction. The plurality of substantially linear prisms include a corresponding plurality of substantially linear prism tips extending along the longitudinal direction. The reflective polarizer includes a plurality of polymeric microlayers numbering at least 10 in total. Each of the polymeric microlayers has an average thickness of less than about 500 nm. For a substantially normally incident light, and for at least one visible wavelength in a visible wavelength range extending from about 420 nm to about 680 nm, and mutually orthogonal in-plane pass and block directions, the plurality of polymeric microlayers has an average optical reflectance of greater than about 60% when the incident light is polarized along the block direction and an average optical transmittance of greater than about 60% when the incident light is polarized along the pass direction. At least some of the substantially linear prism tips of the prismatic film penetrate the second adhesive layer. The lens film includes a plurality of microlenses facing away from the prismatic film and arranged to form a two-dimensional array of the microlenses. The optical stack has an integral construction, and wherein for the pass direction and the at least one visible wavelength, the optical stack has an on-axis effective transmission of at least about 1.5 along a thickness direction of the optical stack and an oblique effective transmission of at most about 1.2 along an oblique direction making an oblique angle of at least about 40 degrees with the thickness direction.

In some aspects of the present description, an integral optical film is provided, the integral optical stack including at least one prismatic film, a lens film disposed on the at least one prismatic film and having a plurality of microlenses, and a reflective polarizer disposed between the lens film and the at least one prismatic film. The prismatic film includes a plurality of substantially linear prisms extending along a same longitudinal direction and arranged along an orthogonal transverse direction. The plurality of substantially linear prisms include a corresponding plurality of substantially linear prism tips extending along the longitudinal direction. The lens film includes a plurality of microlenses arranged to form a two-dimensional regular array. The reflective polarizer includes a plurality of polymeric microlayers numbering at least 10 in total. Each of the polymeric microlayers has an average thickness of less than about 500 nm. For a substantially normally incident light, and for at least one visible wavelength in a visible wavelength range extending from about 420 nm to about 680 nm, and mutually orthogonal in-plane pass and block directions, the plurality of polymeric microlayers has an average optical reflectance of greater than about 60% when the incident light is polarized along the block direction and an average optical transmittance of greater than about 60% when the incident light is polarized along the pass direction. The optical stack has an integral construction. When the at least one prismatic film is one prismatic film, then the integral optical stack has an on-axis effective transmission ET1 along a thickness direction of the optical stack. When the at least one prismatic film is a first prismatic film disposed on a second prismatic film, and wherein the longitudinal directions of the first and second prismatic films make an angle of at least about 30 degrees therebetween, then the integral optical stack has an on-axis effective transmission ET2 along the thickness direction, such that ET1>ET2≥1.5.

### BRIEF DESCRIPTION OF THE DRAWINGS

FIGS. 1A and 1B provide side views of a backlight of an optical system including a display panel, in accordance with an embodiment of the present description;

FIG. 2 is an image of a cross-section of an integral optical stack, in accordance with an embodiment of the present description; and

FIG. 3 is a top, plan view of a lens layer of an integral optical stack, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

There is a need in the manufacture of displays (e.g., liquid crystal displays, or LCDs) for an optical film (e.g., a reflective polarizer, prism sheets, etc.) that provides a sufficient gain in luminance for use in mainstream products but which is less expensive than currently available optical film products which are used in the manufacture of premium display products and other optical applications. According to some aspects of the present description, an optical stack including a reflective polarizer with a micro-lens coating laminated to a prism layer enables increased collimation over existing beaded coatings in a simplified stack structure.

According to some aspects of the present description, a backlight of an optical system having a display panel includes an optical stack. The optical stack may include a prismatic film having a structured first major surface and an opposite second major surface, a first adhesive layer disposed on the second major surface, opposite the structured first major surface of the prismatic film, a reflective polarizer disposed on the structured first major surface, opposite the second major surface of the prismatic film, a second adhesive layer disposed between the reflective polarizer and prismatic film and bonding the reflective polarizer to the prismatic film, and a lens film disposed on, and bonded to, the reflective polarizer opposite the second adhesive layer and substantially co-extensive in width and length with the reflective polarizer. In some embodiments, the backlight may further include a light source configured to emit light toward the optical stack.

In some embodiments, the structured major surface of the prismatic film may include a plurality of substantially linear prisms extending along a same longitudinal direction (e.g., a y-axis of the film) and arranged along an orthogonal transverse direction (e.g., an x-axis of the film). In some embodiments, the plurality of substantially linear prisms may include a corresponding plurality of substantially linear prism tips (i.e., peaks of the prisms) extending along the longitudinal direction.

In some embodiments, the reflective polarizer may include a plurality of polymeric microlayers numbering at least 10, or at least 25, or at least 50, or at least 100, or at least 150, or at least 200, or at least 250, or at least 300, or at least 350, or at least 400 in total. In some embodiments, each of the polymeric microlayers has an average thickness of less than about 500 nm, or less than about 450 nm, or less than about 400 nm, or less than about 350 nm, or less than about 300 nm, or less than about 250 nm, or less than about 200 nm, or less than about 150 nm.

In some embodiments, for a substantially normally incident light (i.e., a light incident such that it is substantially orthogonal to a planar surface of the film), and for at least one visible wavelength in a visible wavelength range extending from about 420 nm to about 680 nm, and mutually orthogonal in-plane pass (e.g., aligned to an x-axis of the film) and block (e.g., aligned to a y-axis of the film) directions, the plurality of polymeric microlayers may have an average optical reflectance of greater than about 60%, or greater than about 70%, or greater than about 80%, or greater than about 90% when the incident light is polarized along the block direction and an average optical transmittance of greater than about 60%, or greater than about 70%, greater than about 80%, greater than about 90% when the incident light is polarized along the pass direction.

In some embodiments, at least some of the substantially linear prism tips of the prismatic film may penetrate (e.g., are embedded in) the second adhesive layer. In some embodiments, the lens film may include a plurality of microlenses facing away from the prismatic film and arranged to form a two-dimensional array of the microlenses. In some embodiments, the optical stack may have an integral construction, and wherein for the pass direction and the at least one visible wavelength, the optical stack may have an on-axis effective transmission of at least about 1.5, or at least about 1.6, or at least about 1.7, or at least about 1.8, or at least about 1.9, or at least about 2, or at least about 2.1, or at least about 2.2 along a thickness direction of the optical stack and an oblique effective transmission of at most about 1.2, or at most about 1.1, or at most about 1.0, or at most about 0.9, or at most about 0.8, or at most about 0.7, or at most about 0.6 along an oblique direction making an oblique angle of at least about 40 degrees, or at least about 45 degrees, or at least about 50 degrees, or at least about 55 degrees, or at least about 60 degrees with the thickness direction. In some embodiments, a ratio of the on-axis effective transmission to the oblique effective transmission may be at least 2.5, or at least 2.8, or at least 3, or at least 3.2, or at least 3.4, or at least 3.6, or at least 3.8, or at least 4, or at least 4.2.

The effective transmission refers to the luminous transmittance of substantially normally incident light. The incident light can be understood to be unpolarized light, except where indicated differently. The average effective transmission is the effective transmission determined over, or averaged over, substantially the entire area of the optical film or determined over, or averaged over, an area sufficiently large (e.g., a diameter of at least about 0.5 mm, or at least about 1 mm, or at least about 5 mm) to average out the effects of local nonuniformities (e.g., clustering of particles). The average effective transmission can be determined as the luminous transmittance determined according to ASTM D1003-13. As indicated in the ASTM D1003-13 test standard, the luminous transmittance is transmittance weighted according to the spectral luminous efficiency function V( ) of the 1987 Commission Internationale de l'Éclairage (CIE).

In some embodiments, the lens film may further include a lens substrate, wherein the microlenses are disposed on the lens substrate. In some embodiments, the lens film may be bonded to the reflective polarizer via an adhesive layer. In some embodiments, the lens film may be coated onto the reflective polarizer. In some embodiments, the prismatic film may further include a prism substrate, wherein the substantially linear prisms are disposed on the prism substrate. In some embodiments, the optical stack may be bonded to a stack substrate via an adhesive layer. In some such embodiments, the stack substrate may have an average thickness of at least 0.5 mm, or at least 0.75 mm, or at least 1 mm, or at least 1.25 mm, or at least 1.5 mm.

In some embodiments, the two-dimensional array of microlenses may include a hexagonal close-packing of the microlenses. In some embodiments, the microlenses may be disposed at an average lens pitch of greater than about 5 microns and less than about 100 microns. In some embodiments, the microlenses may have an average lens height of greater than about 0.5 microns and less than about 20 microns (e.g., about 11 microns). In some embodiments, the microlenses may be substantially spherical microlenses with an average diameter of greater than about 1 micron and less than about 200 microns (e.g., about 30 microns).

In some embodiments, the reflective polarizer may further include at least one skin layer having an average thickness of greater than about 0.5 microns, or greater than about 0.75 microns, or greater than about 1 micron, or greater than about 1.5 microns, or greater than about 2 microns, or greater than about 3 microns, or greater than about 4 microns, or greater than about 5 microns, or greater than about 10 microns, or greater than about 15 microns, or greater than about 20 microns, or greater than about 25 microns, or greater than about 30 microns.

In some embodiments, an optical system may include a display panel disposed on the any of the backlights described herein so that the optical stack is disposed between the display panel and a light source, wherein the display panel is configured to receive the emitted light and form an image for viewing by a viewer.

According to some aspects of the present description, an integral optical stack may include at least one prismatic film, a lens film disposed on the at least one prismatic film and having a plurality of microlenses, and a reflective polarizer disposed between the lens film and the at least one prismatic film. The optical stack may have an integral construction.

In some embodiments, the prismatic film may include a plurality of substantially linear prisms extending along a same longitudinal direction (e.g., an x-axis or a y-axis of the film) and arranged along an orthogonal transverse direction (e.g., a y-axis or an x-axis of the film). In some embodiments, the plurality of substantially linear prisms may include a corresponding plurality of substantially linear prism tips extending along the longitudinal direction.

In some embodiments, the lens film may include a plurality of microlenses arranged to form a two-dimensional regular array. In some embodiments, the reflective polarizer may include a plurality of polymeric microlayers numbering at least 10, or at least 25, or at least 50, or at least 100, or at least 150, or at least 200, or at least 250, or at least 300, or at least 350, or at least 400 in total. In some embodiments, each of the polymeric microlayers may have an average thickness of less than about 500 nm, or less than about 450 nm, or less than about 400 nm, or less than about 350 nm, or less than about 300 nm, or less than about 250 nm, or less than about 200 nm, or less than about 150 nm.

In some embodiments, for a substantially normally incident light, and for at least one visible wavelength in a visible wavelength range extending from about 420 nm to about 680 nm, and mutually orthogonal in-plane pass and block directions, the plurality of polymeric microlayers may have an average optical reflectance of greater than about 60%, greater than about 70%, greater than about 80%, greater than about 90% when the incident light is polarized along the block direction and an average optical transmittance of greater than about 60%, greater than about 70%, greater than about 80%, greater than about 90% when the incident light is polarized along the pass direction.

In some embodiments, when the at least one prismatic film is one prismatic film (i.e., a single prismatic film), then the integral optical stack may have an on-axis effective transmission ET1 along a thickness direction (e.g., a z-axis) of the optical stack. In some embodiments, when the at least one prismatic film is a first prismatic film disposed on a second prismatic film, and wherein the longitudinal directions of the first and second prismatic films make an angle of at least about 30 degrees, or at least about 40 degrees, or at least about 50 degrees, or at least about 60 degrees, or at least about 70 degrees, or at least about 80 degrees, or at least about 90 degrees therebetween, then the integral optical stack may have an on-axis effective transmission ET2 along the thickness direction, such that ET1>ET2≥1.5, or 1.6, or 1.7, or 1.8, or 1.9, or 2.0.

In some embodiments, the integral optical stack may have an oblique effective transmission of at most about 1.2, or at most about 1.1, or at most about 1.0, or at most about 0.9, or at most about 0.8, or at most about 0.7, or at most about 0.6 along an oblique direction making an oblique angle of at least about 40 degrees, or at least about 45 degrees, or at least about 50 degrees, or at least about 55 degrees, or at least about 60 degrees with the thickness direction. In some such embodiments, a ratio of the on-axis effective transmission to the oblique effective transmission is at least 2.5, or at least 2.8, or at least 3, or at least 3.2, or at least 3.4, or at least 3.6, or at least 3.8, or at least 4, or at least 4.2.

In some embodiments, the lens film may further include a lens substrate, wherein the plurality of microlenses are disposed on the lens substrate. In some embodiments, the microlenses are disposed at an average lens pitch of greater than about 5 microns and less than about 100 microns. In some embodiments, the microlenses may have an average lens height of greater than about 0.5 microns and less than about 20 microns. In some embodiments, the microlenses may be substantially spherical microlenses with an average diameter of greater than about 1 micron and less than about 200 microns.

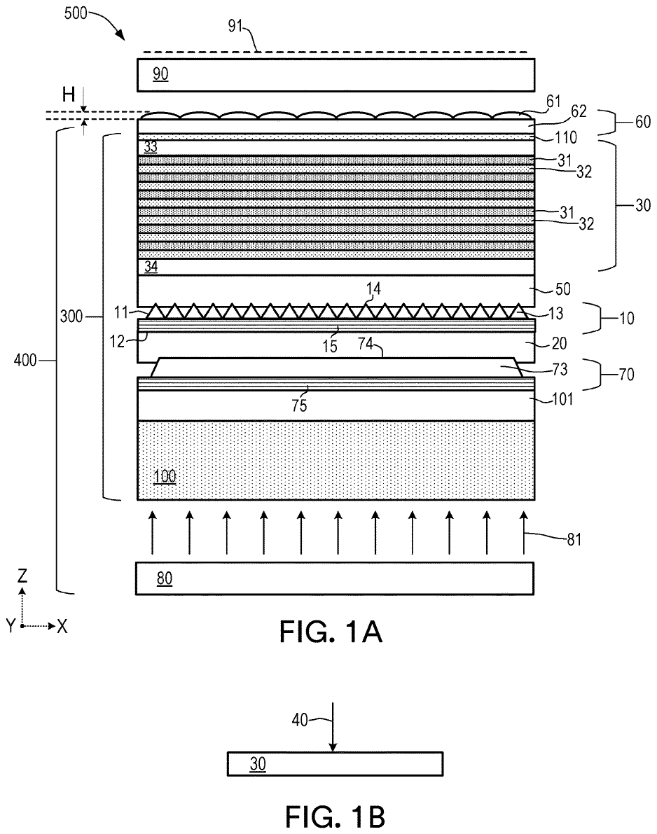

Turning now to the figures, FIGS. 1A and 1B provide side views of an embodiment of a backlight of an optical system including a display panel, according to the present description. In some embodiments, an optical system 500 may include a display panel 90 and a backlight 400. In some embodiments, backlight 400 may include an optical stack 300 and a light source 80, wherein light source 80 is configured to emit light 81 toward optical stack 300. In some embodiments, display panel 90 may be configured to emit an image 91 for viewing by a viewer (not shown).

In some embodiments, optical stack 300 may include at least one prismatic film 10, a reflective polarizer 30, and a micro-lens layer (i.e., lens film) 60. In some embodiments, prismatic film 10 may include a structured first major surface 11 and an opposite second major surface 12. In some embodiments, the structured first major surface 11 may include a plurality of substantially linear prisms 13 extending along a same longitudinal direction (e.g., the y-axis shown in FIG. 1A) and arranged along an orthogonal transverse direction (e.g., the x-axis shown in FIG. 1A). In some embodiments, the plurality of substantially linear prisms 13 may include a corresponding plurality of substantially linear prism tips (e.g., prism peaks) 14 extending along the same longitudinal direction. In some embodiments, prismatic film 10 may further comprise a prism substrate 15, wherein substantially linear prisms 13 are disposed on prism substrate 15. In some embodiments, optical stack 30 may further include a first adhesive layer 20 disposed on the second major surface 12 opposite the structured first major surface 11 of prismatic film 10.

In some embodiments, reflective polarizer 30 may be disposed on the structured first major surface 11 opposite the second major surface 12 of prismatic film 10. In some embodiments, reflective polarizer 30 may include a plurality of alternating polymeric microlayers 31, 32 numbering at least 10, or at least 25, or at least 50, or at least 100, or at least 150, or at least 200, or at least 250, or at least 300, or at least 350, or at least 400 in total. In some embodiments, each of the polymeric microlayers may have an average thickness of less than about 500 nm, or less than about 450, or less than about 400, or less than about 350, or less than about 300, or less than about 250, or less than about 200, or less than about 150 nm. In some embodiments, alternating polymeric microlayers 31, 32 may have differing indices of refraction, or may demonstrate varying thicknesses (e.g., a varying thickness gradient across reflective polarizer 30) such that reflective polarizer 30 may be configured to reflect or transmit predetermined amounts of certain wavelengths and/or polarization types. For example, in some embodiments, for a substantially normally incident light 40 on reflective polarizer 30 (see FIG. 1A), for at least one visible wavelength in a visible wavelength range extending from about 420 nm to about 680 nm, and mutually orthogonal in-plane pass (e.g., aligned with the x-axis shown in FIG. 1A) and block (e.g., aligned with the y-axis shown in FIG. 1A) directions, the plurality of polymeric microlayers 31, 32 may have an average optical reflectance of greater than about 60% when incident light 40 is polarized along the block direction and an average optical transmittance of greater than about 60% when incident light 40 is polarized along the pass direction. As another example, in some embodiments, and wherein for the pass direction and the at least one visible wavelength, the optical stack may have an on-axis effective transmission of at least about 1.5, or at least about 1.6, or at least about 1.7, or at least about 1.8, or at least about 1.9, or at least about 2, or at least about 2.1, or at least about 2.2 (e.g., about 2.23) along a thickness direction (e.g., the z-axis of FIG. 1A) of optical stack 300, and an oblique effective transmission of at most about 1.2, or at most about 1.1, or at most about 1.0, or at most about 0.9, or at most about 0.8, or at most about 0.7, or at most about 0.6 (e.g., about 0.53) along an oblique direction making an oblique angle of at least about 40 degrees, or at least about 45 degrees, or at least about 50 degrees, or at least about 55 degrees, or at least about 60 degrees with the thickness direction of optical stack 300. Stated another way, the on-axis effective transmission of optical stack 300 may be greater than the oblique effective transmission of optical stack 300. In some embodiments, the ratio of the on-axis effective transmission of optical stack 300 to the oblique effective transmission of optical stack 300 may be at least about 1.25, or at least about 1.5, or at least about 1.75, or at least about 2, or at least about 2.5, or at least about 3, or at least about 3.5.

In some embodiments, the reflective polarizer may further include at least one skin layer 33, 34 having an average thickness of greater than about 0.5 microns (or greater than about 0.75 microns, or greater than about 1 microns, or greater than about 1.5 microns, or greater than about 2 microns, or greater than about 3 microns, or greater than about 4 microns, or greater than about 5 microns, or greater than about 10 microns, or greater than about 15 microns, or greater than about 20 microns, or greater than about 25 microns, or greater than about 30 microns.

In some embodiments, optical stack 300 may further include a second adhesive layer 50 disposed between reflective polarizer 30 and prismatic film 10, bonding reflective polarizer 30 to prismatic film 10 such that at least some of the substantially linear prism tips 14 penetrate second adhesive layer 50.

In some embodiments, lens film 60 may be disposed on, and bonded to, reflective polarizer 30 opposite second adhesive layer 50 and substantially co-extensive in width (e.g., the x-axis) and length (e.g., the y-axis) with reflective polarizer 30. In some embodiments, lens film 60 may include a plurality of microlenses 61 facing away from prismatic film 10 and arranged to form a two-dimensional array of microlenses 61. In some embodiments, lens film 60 may further include a lens substrate 62, wherein microlenses 61 are disposed on lens substrate 62. In some embodiments, lens film 60 may be bonded to reflective polarizer 30 via an adhesive layer 110.

In some embodiments, the at least one prismatic film 10 may be a first prismatic film 10 disposed on a second prismatic film 70. In some such embodiments, second prismatic film 70 may include a second plurality of linear prisms 73 having linear prism tips 74. In some such embodiments, second plurality of linear prisms 73 may be disposed on a second prism substrate 75. In some embodiments, the longitudinal directions of the first 10 and second 70 prismatic films may make an angle of at least about 30 degrees, or at least about 40 degrees, or at least about 50 degrees, or at least about 60 degrees, or at least about 70 degrees, or at least about 80 degrees, or at least about 90 degrees therebetween (e.g., the longitudinal direction of the first linear prisms 13 of first prismatic film 10 may be orthogonal to the longitudinal direction of the second linear prisms 73 of second prismatic film 70).

In some such embodiments (having a first prismatic film 10 and a second prismatic film 70), the on-axis effective transmission of incident light may be less than the on-axis effective transmission of an embodiment having only a single prismatic film 10. For example, when the at least one prismatic film is a single prismatic film 10, the integral optical stack 300 may have an on-axis effective transmission ET1 along a thickness direction (e.g., the z-axis shown in FIG. 1A) of the optical stack, and when the at least one prismatic film is a first prismatic film 10 disposed on a second prismatic film 70, then the integral optical stack may have an on-axis effective transmission ET2 along the thickness direction. In some such embodiments, ET1 may be greater than ET2, and ET2 may be greater than or equal to about 1.5, or about 1.6, or about 1.7, or about 1.8, or about 1.9, or about 2. Stated another way, the on-axis effective transmission of an optical stack 300 having a single prismatic film 10 may be greater than the corresponding on-axis effective transmission of an optical stack 300 having both a first prismatic film 10 and a second prismatic film 70.

In some embodiments, optical stack 300 may be bonded to a stack substrate 100 via an adhesive layer 101. In some such embodiments, the stack substrate may have an average thickness of at least 0.5 mm, or at least 0.75 mm, or at least 1 mm, or at least 1.25 mm, or at least 1.5 mm.

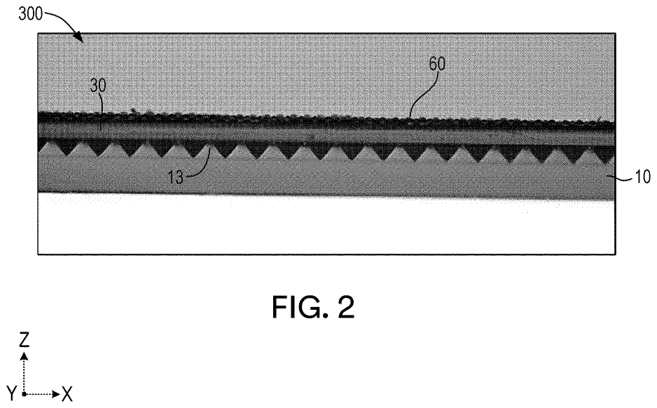

FIG. 2 is an image of a cross-section of an embodiment of an integral optical stack, such as integral optical stack 300 of FIG. 1A, showing an actual representative stack. In this embodiment, optical stack 300 include a lens film 60 disposed on a reflective polarizer 30, which is in turn disposed on, and bonded to, a prism film 10 including a plurality of linear prisms 13. In some embodiments, lens film 60 may be coated onto reflective polarizer 30.

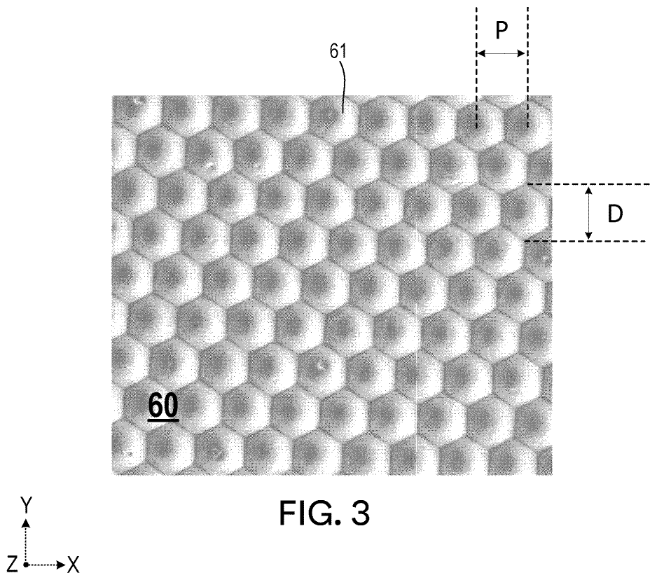

FIG. 3 is a top, plan view of an embodiment of a lens layer of an integral optical stack, such as lens layer 60 of FIG. 1A. In some embodiments, lens layer 60 includes a plurality of micro-lenses 61. In some embodiments, such as the embodiment of FIG. 3, the two-dimensional array of microlenses 61 may include a hexagonal close-packing of microlenses 61. In some embodiments, microlenses 61 may be disposed at an average lens pitch, P, of greater than about 5 microns and less than about 100 microns. In some embodiments, microlenses 61 may have an average lens height (e.g., height, H, above lens substrate 62, as shown in FIG. 1A) of greater than about 0.5 microns and less than about 20 microns (e.g., about 11 microns). In some embodiments, microlenses 61 may be substantially spherical microlenses with an average diameter, D, of greater than about 1 micron and less than about 200 microns (e.g., about 30 microns). The dimensions discussed herein are examples only and are not intended to be limiting. The microlenses may have various shapes, sizes, pitches, and arrangements and still be within the scope of the present disclosure.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A backlight of an optical system comprising a display panel, the backlight comprising an optical stack comprising:
a prismatic film comprising a structured first major surface and an opposite second major surface, the structured first major surface comprising a plurality of substantially linear prisms extending along a same longitudinal direction and arranged along an orthogonal transverse direction, the plurality of substantially linear prisms comprising a corresponding plurality of substantially linear prism tips extending along the longitudinal direction;
a first adhesive layer disposed on the second, opposite the structured first, major surface of the prismatic film;
a reflective polarizer disposed on the structured first major, opposite the second major, surface of the prismatic film and comprising a plurality of polymeric microlayers numbering at least 10 in total, each of the polymeric microlayers having an average thickness of less than about 500 nm, such that for a substantially normally incident light, for at least one visible wavelength in a visible wavelength range extending from about 420 nm to about 680 nm, and mutually orthogonal in-plane pass and block directions, the plurality of polymeric microlayers has an average optical reflectance of greater than about 60% when the incident light is polarized along the block direction and an average optical transmittance of greater than about 60% when the incident light is polarized along the pass direction;
a second adhesive layer disposed between the reflective polarizer and prismatic film and bonding the reflective polarizer to the prismatic film such that at least some of the substantially linear prism tips penetrate the second adhesive layer; and
a lens film disposed on, and bonded to, the reflective polarizer opposite the second adhesive layer and substantially co-extensive in width and length with the reflective polarizer, the lens film comprising a plurality of microlenses facing away from the prismatic film and arranged to form a two-dimensional array of the microlenses, wherein the optical stack has an integral construction, and wherein for the pass direction and the at least one visible wavelength, the optical stack has an on-axis effective transmission of at least about 1.5 along a thickness direction of the optical stack and an oblique effective transmission of at most about 1.2 along an oblique direction making an oblique angle of at least about 40 degrees with the thickness direction.

2. The backlight of claim 1, wherein a ratio of the on-axis effective transmission to the oblique effective transmission is at least 2.5.

3. The backlight of claim 1 further comprising a light source configured to emit light toward the optical stack.

4. An optical system comprising a display panel disposed on the backlight of claim 3 so that the optical stack is disposed between the display panel and the light source, the display panel configured to receive the emitted light and form an image.

5. The backlight of claim 1, wherein the lens film further comprises a lens substrate, and wherein the microlenses are disposed on the lens substrate.

6. The backlight of claim 1, wherein the lens film is bonded to the reflective polarizer via an adhesive layer.

7. The backlight of claim 1, wherein the lens film is coated onto the reflective polarizer.

8. The backlight of claim 1, wherein the two-dimensional array of the microlenses comprises a hexagonal close-packing of the microlenses.

9. The backlight of claim 1, wherein the microlenses are disposed at an average lens pitch of greater than about 5 microns and less than about 100 microns.

10. The backlight of claim 1, wherein the microlenses have an average lens height of greater than about 0.5 microns and less than about 20 microns.

11. The backlight of claim 1, wherein the microlenses are substantially spherical microlenses with an average diameter of greater than about 1 micron and less than about 200 microns.

12. The backlight of claim 1, wherein the reflective polarizer further comprises at least one skin layer having an average thickness of greater than about 0.5 microns.

13. The backlight of claim 1, wherein the prismatic film further comprises a prism substrate, and wherein the substantially linear prisms are disposed on the prism substrate.

14. The backlight of claim 1, wherein the optical stack is bonded to a stack substrate via an adhesive layer, the stack substrate having an average thickness of at least 0.5 mm.

15. An integral optical stack comprising:
at least one prismatic film comprising a plurality of substantially linear prisms extending along a same longitudinal direction and arranged along an orthogonal transverse direction, the plurality of substantially linear prisms comprising a corresponding plurality of substantially linear prism tips extending along the longitudinal direction;
a lens film disposed on the at least one prismatic film and comprising a plurality of microlenses arranged to form a two-dimensional regular array of the micro-lenses; and
a reflective polarizer disposed between the lens film and the at least one prismatic film and comprising a plurality of polymeric microlayers numbering at least 10 in total, each of the polymeric microlayers having an average thickness of less than about 500 nm, such that for a substantially normally incident light, for at least one visible wavelength in a visible wavelength range extending from about 420 nm to about 680 nm, and mutually orthogonal in-plane pass and block directions, the plurality of polymeric microlayers has an average optical reflectance of greater than about 60% when the incident light is polarized along the block direction and an average optical transmittance of greater than about 60% when the incident light is polarized along the pass direction;
wherein, the optical stack has an integral construction;
wherein, when the at least one prismatic film is one prismatic film, then the integral optical stack has an on-axis effective transmission ET1 along a thickness direction of the optical stack; and
wherein, when the at least one prismatic film is a first prismatic film disposed on a second prismatic film, and wherein the longitudinal directions of the first and second prismatic films make an angle of at least about 30 degrees therebetween, then the integral optical stack has an on-axis effective transmission ET2 along the thickness direction, ET1>ET2≥1.5.

16. The integral optical stack of claim 15, wherein the integral optical stack has an oblique effective transmission of at most about 1.2 along an oblique direction making an oblique angle of at least about 40 degrees with the thickness direction.

17. The integral optical stack of claim 16, wherein a ratio of the on-axis effective transmission to the oblique effective transmission is at least 2.5.

18. (canceled)

19. The integral optical stack of claim 15, wherein the microlenses are disposed at an average lens pitch of greater than about 5 microns and less than about 100 microns.

20. The integral optical stack of claim 15, wherein the microlenses have an average lens height of greater than about 0.5 microns and less than about 20 microns.

21. The integral optical stack of claim 15, wherein the microlenses are substantially spherical microlenses with an average diameter of greater than about 1 micron and less than about 200 microns.
